(19) United States
(12) Patent Application Publication
(10) Pub. No.: US 2022/0360174 A1
(43) Pub. Date: Nov. 10, 2022

(54) BASIC UNIT FOR POWER CONVERTER, POWER CONVERTER, AND UNIVERSAL POWER INTERFACE

(71) Applicant: Tianjin University, Tianjin (CN)

(72) Inventors: Yifeng WANG, Tianjin (CN); Xiaoyong MA, Tianjin (CN); Ping WANG, Tianjin (CN); Long TAO, Tianjin (CN); Pengyu CHENG, Tianjin (CN); Ningyi LIANG, Tianjin (CN); Danfeng ZHAO, Tianjin (CN)

(21) Appl. No.: 17/462,940

(22) Filed: Aug. 31, 2021

(30) Foreign Application Priority Data
May 6, 2021 (CN) 202110490270.5

(51) Int. Cl. H02M 3/158; H02M 7/219; H02M 7/5387

(52) U.S. Cl. CPC H02M 3/1582; H02M 3/1584; H02M 7/219; H02M 7/53875

(57) ABSTRACT

A basic unit for a power converter, a power converter, and a universal power interface are disclosed. The basic unit includes an inductor, a power half-bridge, a first terminal, a second terminal, a third terminal, and a fourth terminal, where an end of the inductor is connected to a midpoint of the power half-bridge, and the other end of the inductor is connected to the first terminal; a source terminal of a lower bridge arm of the power half-bridge is connected to the second terminal and the fourth terminal; and a drain terminal of an upper bridge arm of the power half-bridge is connected to the third terminal. The manufacturing costs of a microgrid system and the difficulty of later maintenance can be reduced.

### CROSS REFERENCE TO RELATED APPLICATION(S)

This patent application claims the benefit and priority of Chinese Patent Application No. 202110490270.5 filed on May 06, 2021, the disclosure of which is incorporated by reference herein in its entirety as part of the present application.

### TECHNICAL FIELD

The present disclosure relates to the microgrid field, and in particular, to a basic unit for a power converter, a power converter, and a universal power interface.

### BACKGROUND

An alternating current (AC)/direct current (DC) hybrid microgrid is an important part of a smart grid. Compared with a single AC or DC microgrid, hybrid microgrids can provide power support to each other, thereby improving the power supply reliability of a system and the power supply stability of important loads. In a hybrid microgrid, power conversions are common, for example, single-phase rectification and inversion, DC step-up, DC step-down, and three-phase rectification and inversion. To implement the power conversions, converters that differ greatly in topologies and functions are used, and converters corresponding to different power conversions cannot replace each other. As a result, both the manufacturing costs of the system and the difficulty of later maintenance are increased.

### SUMMARY

An object of the present disclosure is to provide a basic unit for a power converter, a power converter, and a universal power interface, to reduce the manufacturing costs of a microgrid system and the difficulty of later maintenance.

To achieve the above objective, the present disclosure provides the following technical solutions:

A basic unit for a power converter is provided. The basic unit includes an inductor, a power half-bridge, a first terminal, a second terminal, a third terminal, and a fourth terminal, where an end of the inductor is connected to a midpoint of the power half-bridge, and another end of the inductor is connected to the first terminal; a source terminal of a lower bridge arm of the power half-bridge is connected to the second terminal and the fourth terminal; and a drain terminal of an upper bridge arm of the power half-bridge is connected to the third terminal.

The present disclosure further provides a power converter. The power converter includes the foregoing basic unit, and there are 3 to 6N basic units in the power converter, where N is an integer greater than 1; third terminals of all the basic units in the power converter are connected to a first terminal of an output capacitor and a positive terminal of a DC bus; and fourth terminals of all the basic units in the power converter are connected to a second terminal of the output capacitor and a negative terminal of the DC bus.

The present disclosure further provides a universal power interface, where the universal power interface is used for the foregoing power converter, and the power converter is connected to a load or an energy source in a microgrid through the universal power interface;

the universal power interface includes a first power interface and a second power interface, the first power interface includes 6N first terminals and 6N second terminals, the second power interface includes 6N third terminals and 6N fourth terminals, the 6N first terminals of the first power interface are connected to the 6N third terminals of the second power interface in a one-to-one correspondence, and the 6N second terminals of the first power interface are connected to the 6N fourth terminals of the second power interface in a one-to-one correspondence, where N is an integer greater than 0:

first terminals of all basic units in the power converter are connected to a plurality of first terminals of the first power interface in a one-to-one correspondence, and second terminals of all the basic units in the power converter are connected to a plurality of second terminals of the first power interface in a one-to-one correspondence; and

the load or the energy source in the microgrid is connected to the second power interface.

According to specific embodiments provided in the present disclosure, the present disclosure discloses the following technical effects.

The basic unit provided in the present disclosure can be applicable to various types of power converters and has good versatility. The power converter provided in the present disclosure is composed of universal basic units, and can implement different power conversion functions. As a result, the system design is simplified, the manufacturing costs are reduced, and later maintenance is facilitated.

In addition, the present disclosure provides a universal power interface, making connection modes between a standard power converter and various types of loads or energy sources in a microgrid become uniform. As a result, the system wiring is simplified, the manufacturing costs are further reduced, and later maintenance of the hybrid microgrid is facilitated.

### BRIEF DESCRIPTION OF DRAWINGS

To describe the technical solutions in the embodiments of the present disclosure or in the prior art more clearly, the following briefly describes the accompanying drawings required for the embodiments. Apparently, the accompanying drawings in the following description show merely some embodiments of the present disclosure, and persons of ordinary skill in the art may still derive other accompanying drawings from these accompanying drawings without creative efforts.

FIG. 1 is a schematic structural diagram of a basic unit according to the present disclosure;

FIG. 2 is a schematic connection diagram of a basic unit when a power converter is used for DC step-up or DC step-down according to the present disclosure;

FIG. 3 is a schematic connection diagram of a basic unit when a power converter is used for single-phase rectification and inversion according to the present disclosure;

FIG. 4 is a schematic connection diagram of a basic unit when a power converter is used for three-phase rectification and inversion according to the present disclosure;

FIG. 5 is a schematic connection diagram of a universal power interface and a power converter according to the present disclosure;

FIG. 6A a schematic connection diagram of a second power interface and a DC load or a DC source according to the present disclosure;

FIG. 6B is a schematic connection diagram of a second power interface and a single-phase AC load or a single-phase AC source according to the present disclosure;

FIG. 6C is a schematic connection diagram of a second power interface and a three-phase AC load or a three-phase AC source according to the present disclosure;

FIG. 7 is a schematic connection diagram of a power converter and a universal power interface according to an embodiment of the present disclosure;

FIG. 8 is a schematic connection diagram of a power converter for implementing a DC-DC function and a universal power interface according to an embodiment of the present disclosure;

FIG. 9 is a schematic connection diagram of a power converter for implementing a photovoltaic maximum power point tracing (MPPT) function and a universal power interface according to an embodiment of the present disclosure;

FIG. 10 is a schematic connection diagram of a power converter for implementing a single-phase rectification and inversion function and a universal power interface according to an embodiment of the present disclosure;

FIG. 11 is a schematic connection diagram of a power converter for implementing a three-phase rectification and inversion function and a universal power interface according to an embodiment of the present disclosure; and

FIG. 12 is a schematic connection diagram of a power converter and a universal power interface in a constructed AC/DC hybrid microgrid system according to an embodiment of the present disclosure.

### DETAILED DESCRIPTION OF THE EMBODIMENTS

The following clearly and completely describes the technical solutions in the embodiments of the present disclosure with reference to accompanying drawings in the embodiments of the present disclosure. Apparently, the described embodiments are merely a part rather than all of the examples of the present disclosure. All other embodiments obtained by persons of ordinary skill in the art based on the embodiments in the present disclosure without creative efforts shall fall within the protection scope of the present disclosure.

There are a plurality of types of loads and energy sources in a microgrid, and power interfaces of these loads and energy sources to corresponding converters are usually different. A power interface of a single-phase load or a single-phase AC source is usually a two-wire interface (including an L terminal and an N terminal). A power interface of a three-phase load or a three-phase AC source is usually a three-phase four-wire interface including a U phase, a V phase, a W phase, and a ground wire. A power interface of a DC load or a DC source is usually a two-wire interface including a DC positive terminal and a DC negative terminal.

Due to the diversity and non-replaceability of power converters, the manufacturing costs of the hybrid microgrid and the difficulty of later maintenance are increased. Moreover, the complexity of the hybrid microgrid is further increased because of the difference of power interfaces. Therefore, it is of great significance to propose a basic unit, a new standard converter topology composed of basic units, and a universal power interface in the present disclosure and construct a standard and modular AC/DC hybrid microgrid according to the present disclosure.

To make the above objects, features, and advantages of the present disclosure more obvious and understandable, the present disclosure is further described in detail below with reference to the accompanying drawings and detailed embodiments.

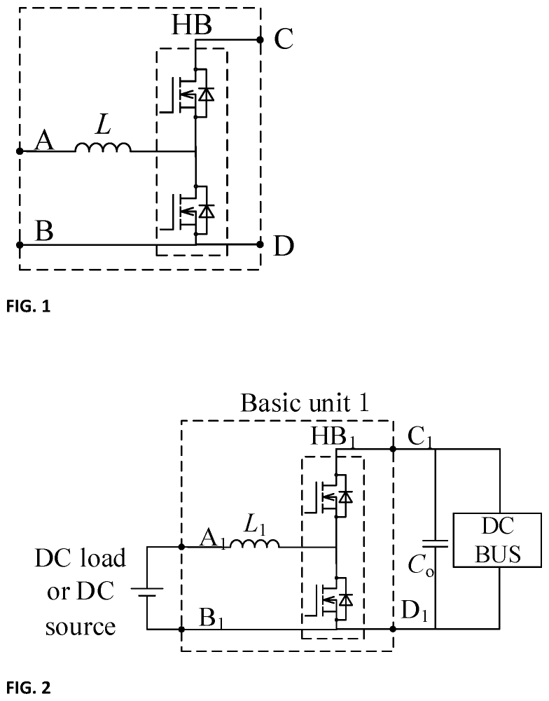

According to the present disclosure, a basic unit for a power converter is firstly proposed. As shown in FIG. 1, the basic unit includes an inductor L, a power half-bridge HB, a first terminal A, a second terminal B, a third terminal C, and a fourth terminal D One end of the inductor L is connected to a midpoint of the power half-bridge HB, and the other end of the inductor L is connected to the first terminal A; a source terminal of a lower bridge arm of the power half-bridge HB is connected to both the second terminal B and the fourth terminal D; and a drain terminal of an upper bridge aim of the power half-bridge HB is connected to the third terminal C. Based on the basic unit, a standard power converter may be formed by using a combination of basic units. The standard power converter can implement various power conversions. For specific connection relationships when the power converter implements different power conversions, refer to FIG. 2 to FIG. 5.

As shown in FIG. 2, a power converter in FIG. 2 is used for DC step-up or DC step-down, and can implement non-isolated bidirectional DC conversion. In this case, the power converter is equivalent to a Buck-Boost converter, and the Buck-Boost converter requires one basic unit.

Therefore, each basic unit is equivalent to a Buck-Boost converter. For each basic unit, a first terminal A₁ and a second terminal B₁ are respectively connected to a positive terminal and a negative terminal of a DC source (or a DC load), a third terminal C₁ is connected to an output capacitor C₀ and a positive terminal of a DC bus DC BUS, and a fourth terminal D₁ is connected to the output capacitor C₀ and a negative terminal of the DC bus DC BUS.

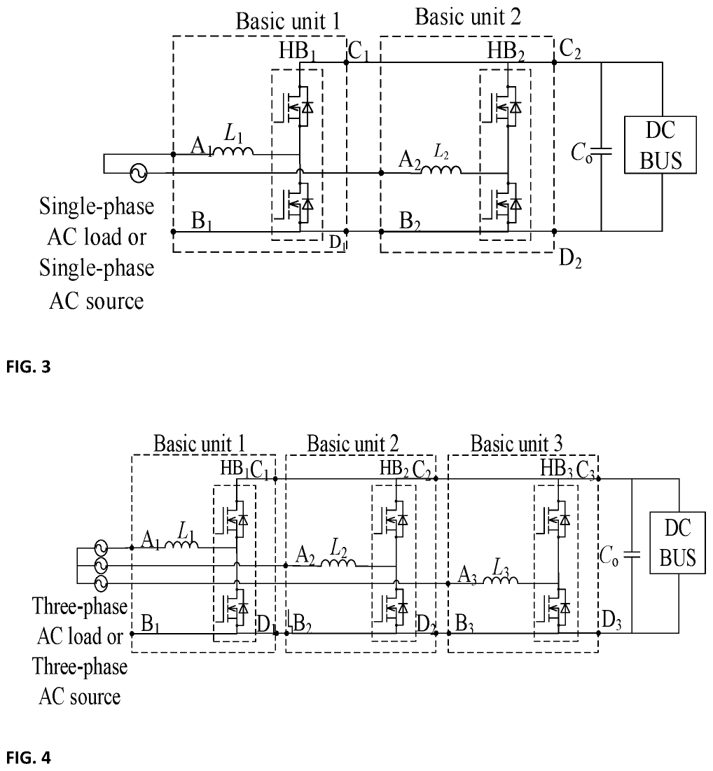

As shown in FIG. 3, a power converter in FIG. 3 is used for single-phase rectification and inversion, and can implement non-isolated single-phase rectification and inversion. In this case, the power converter is equivalent to a single-phase bridge rectification-inversion converter, and the single-phase bridge rectification-inversion converter requires two basic units. Therefore, any two basic units in the power converter can form a single-phase bridge rectification-inversion converter. A subscript of a symbol is corresponding to a reference numeral of a basic unit, that is, a subscript 1 represents a first basic unit and a subscript 2 represents a second basic unit. A terminal A₁ of a basic unit is connected to an L terminal of a single-phase AC source (or a single-phase AC load), a terminal A₂ is connected to an N terminal of the single-phase AC source (or the single-phase AC load), and terminals B₁ and B₂ are floating. Terminals C₁ and C₂ of basic units are connected to an output capacitor and a positive terminal of a DC bus, and terminals D₁ and D₂ are connected to the output capacitor and a negative terminal of the DC bus.

As shown in FIG. 4, a power converter in FIG. 4 is used for three-phase rectification and inversion, and can implement non-isolated three-phase rectification and inversion. In this case, the power converter is equivalent to a three-phase bridge rectification-inversion converter, and the three-phase bridge rectification-inversion converter requires three basic units. Therefore, any three basic units in the power converter can form a three-phase bridge rectification-inversion converter. A subscript of a symbol is corresponding to a reference numeral of a basic unit, that is, a subscript 1 represents a first basic unit, a subscript 2 represents a second basic unit, and a subscript 3 represents a third basic unit. Terminals A₁ to A₃ of basic units are respectively connected to a U phase, a V phase, and a W phase of a three-phase AC source (or a three-phase AC load), terminals B₁ to B₃ of the basic units are floating, terminals C₁ to C₃ are connected to an output capacitor and a positive terminal of a DC bus, and terminals D₁ to D₃ are connected to the output capacitor and a negative terminal of the DC bus.

Based on the foregoing power converter, the present disclosure further provides a universal power interface. The power converter is connected to a corresponding type of load or energy source in a microgrid through the universal power interface, and can implement various power conversions. At least one, two, and three basic units are respectively required for implementing non-isolated power conversions: non-isolated DC step-up or step-down, single-phase rectification and inversion, and three-phase rectification and inversion. To implement all of the foregoing power conversion functions, a standard power converter requires at least three basic units. To effectively use basic units, 6N terminals are designed for each type of terminals of the universal power interface in this application.

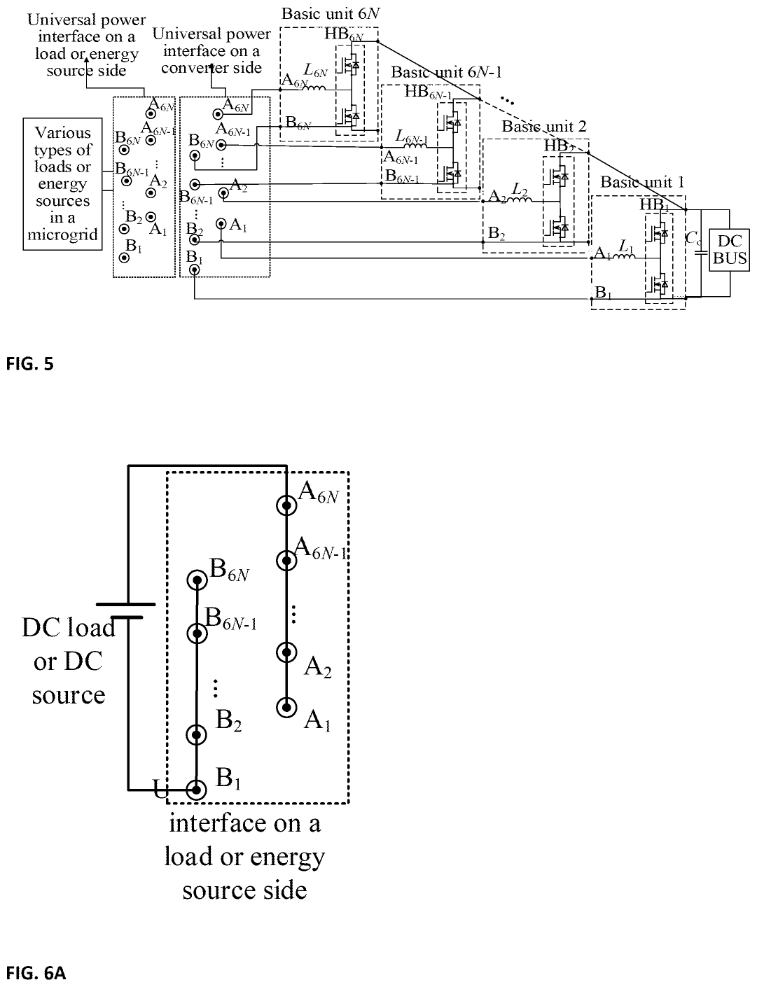

As shown in FIG. 5, a universal power interface includes a first power interface and a second power interface. The first power interface is a part connected to a power converter, and the second power interface is a part connected to a load or an energy source. The first power interface includes 6N first terminals A₁ to A_{6N} and 6N second terminals B₁ to B_{6N}, and the second power interface includes 6N third terminals A₁ to A_{6N} and 6N fourth terminals B₁ to B_{6N}. The 6N first terminals A₁ to A_{6N} of the first power interface are connected to the 6N third terminals A₁ to A_{6N} of the second power interface in a one-to-one correspondence, and the 6N second terminals B₁ to B_{6N} of the first power interface are connected to the 6N fourth terminals B₁ to B_{6N} of the second power interface in a one-to-one correspondence.

When the first power interface is connected to the power converter, first terminals of all basic units in the power converter are connected to a plurality of first terminals of the first power interface in a one-to-one correspondence, and second terminals of all the basic units in the power converter are connected to a plurality of second terminals of the first power interface in a one-to-one correspondence. The maximum number of all the basic units in the power converter is 6N. When the power converter includes 6N basic units, 6N terminals C₁ to C_{6N} of the basic units are connected to an output capacitor and a positive terminal of a DC bus, and 6N terminals D₁ to D_{6N} of the basic units are connected to the output capacitor and a negative terminal of the DC bus. The terminals A₁ to A_{6N} of the first power interface are connected to terminals A₁ to A_{6N} of the basic units, and the terminals B₁ to B_{6N} of the first power interface are connected to terminals B₁ to B_{6N} of the basic units.

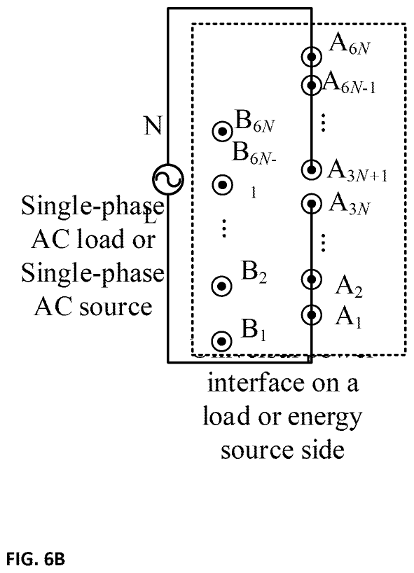

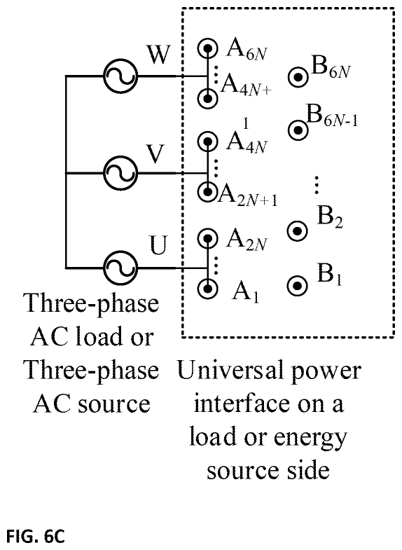

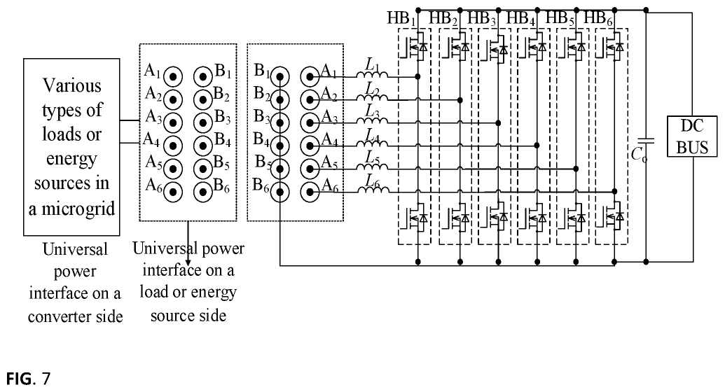

Specifically, when the power converter implements different power conversions, connection modes between the second power interface and the load or the energy source are different. FIG. 6A, is a schematic connection diagram of a second power interface and a DC load or a DC source, FIG. 6B is a schematic connection diagram of a second power interface and a single-phase AC load or a single-phase AC source, and FIG. 6C is a schematic connection diagram of a second power interface and a three-phase AC load or a three-phase AC source.

As shown in FIG. 6A and FIG. 5, the power converter includes m basic units; when the power converter is used for DC step-up or DC step-down, first terminals of the m basic units in the power converter are respectively connected to m first terminals of the first power interface, and second terminals of the m basic units are respectively connected to m second terminals of the first power interface. In this case, m third terminals A₁ to Aₘ of the second power interface that are corresponding to the m first terminals of the first power interface are connected to a positive terminal of a DC load (or a DC source) after being connected in series, and m fourth terminals B₁ to Bₘ of the second power interface that are corresponding to the m second terminals of the first power interface are connected to a negative terminal of the DC load (or the DC source) after being connected in series. Based on the above connection mode, the power converter in this case is equivalent to in Buck-Boost converters.

As shown in FIG. 6B and FIG. 5, the power converter includes 2n basic units; and when the power converter is used for single-phase rectification and inversion, the 2n basic units in the power converter are divided into n groups of basic units, and each group of basic units includes two basic units. First terminals of the 2n basic units in the power converter are respectively connected to 2n first terminals of the first power interface, and second terminals of the 2n basic units are respectively connected to 2n second terminals of the first power interface. In this case, third terminals of the second power interface are divided into two parts, n third terminals A₁ to Aₙ corresponding to a first group of first terminals of the first power interface are connected to an L terminal of a single-phase AC load (or a single-phase AC source) after being connected in series, n third terminals Aₙ₊₁ to A₂ₙ corresponding to a second group of first terminals of the first power interface are connected to an M terminal of the single-phase AC load (or the single-phase AC source) after being connected in series, and fourth terminals B₁ to B_{6N} are floating. Both the first group of first terminals and the second group of first terminals include n terminals, and the first group of first terminals and the second group of first terminals are respectively connected to the first terminals of the 2n basic units in the power converter. Based on the above connection mode, the power converter in this case is equivalent to n single-phase bridge rectification-inversion converters connected in parallel.

As shown in FIG. 6C and FIG. 5, the power converter includes 3h basic units; and when the power converter is used for single-phase rectification and inversion, the 3h basic units in the power converter are divided into h groups of basic units, and each group of basic units includes three basic units. First terminals of the 3h basic units in the power converter are respectively connected to 3h first terminals of the first power interface, and second terminals of the 3h basic units are respectively connected to 3h second terminals of the first power interface. In this case, terminals A₁ to A₃ₕ of the second power interface are divided into three parts on average, h third terminals A₁ to Aₕ of the second power interface that are corresponding to a first group of first terminals of the first power interface are connected to a U phase of a three-phase AC source (or a three-phase AC load) after being connected in series, h third terminals Aₕ₊₁ to A₂ₕ of the second power interface that are corresponding to a second group of first terminals of the first power interface are connected to a V phase of the three-phase AC source (or the three-phase AC load) after being connected in series, h first terminals A₂ₕ₊₁ to A₃ₕ of the second power interface that are corresponding to a third group of first terminals of the first power interface are connected to a W phase of the three-phase AC source (or the three-phase AC load) after being connected in series, and fourth terminals B₁ to B₃ₕ are floating. All of the first group of first terminals, the second group of first terminals, and the second group of third terminals include h terminals, and the first group of first terminals, the second group of first terminals, and the second group of third terminals are respectively connected to the first terminals of the 3h basic units in the power converter. Based on the above connection mode, the standard power converter in this case is equivalent to h three-phase bridge rectification-inversion converters connected in parallel.

A specific embodiment is given below to further describe the foregoing solution in the present disclosure. In this embodiment, a power converter composed of six basic units and a corresponding universal power interface are described. A connection relationship between the power converter and the universal power interface is shown in FIG. 7. Based on this, non-isolated power conversions required by an AC/DC hybrid microgrid can be implemented. Specific implementations are as follows.

### (1) Implementation of Non-Isolated DC-DC Conversion

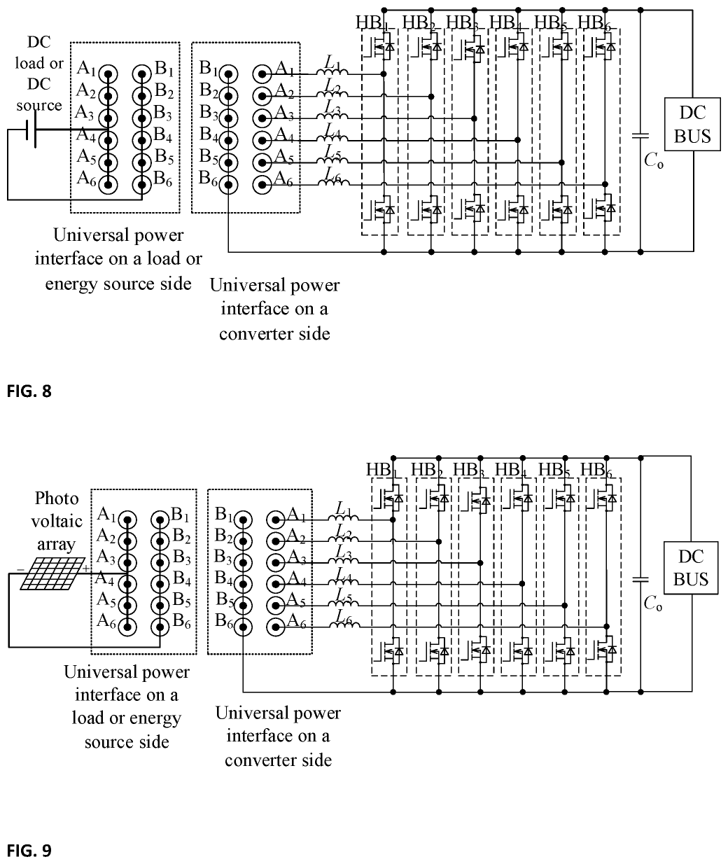

A DC-DC conversion function is implemented based on the power converter and the universal power interface. As shown in FIG. 8, for a second power interface, A₁ to A₆ are connected to a positive terminal of a DC load or a DC source, and B₁ to B₆ are connected to a negative terminal of the DC load or the DC source; and for a first power interface, A₁ to A₆ are connected to inductors of basic units, and B₁ to B₆ are connected to source terminals of lower bridge aims of half-bridges. In this case, the power converter can be used as six BUCK-BOOST converters connected in parallel. Based on this converter, non-isolated DC-DC conversion functions such as DC step-up or step-down and energy bidirectional flow can be implemented.

### (2) Implementation of Non-Isolated Photovoltaic MPPT

A photovoltaic MPPT function is implemented based on the power converter and the universal power interface. As shown in FIG. 9, for a second power interface on a load or energy source side, A₁ to A₆ are connected to a positive terminal of a photovoltaic array, and B₁ to B₆ are connected to a negative terminal of the photovoltaic array; and for a first power interface on a power converter side, A₁ to A₆ are connected to the inductors of the basic units, and B₁ to B₆ are connected to the source terminals of the lower bridge arms of the half-bridges. In this case, the power converter can still be used as six BUCK-BOOST converters connected in parallel. Based on this converter, maximum power point tracing for the photovoltaic array can be implemented.

### (3) Implementation of Non-Isolated Single-Phase Rectification and Inversion

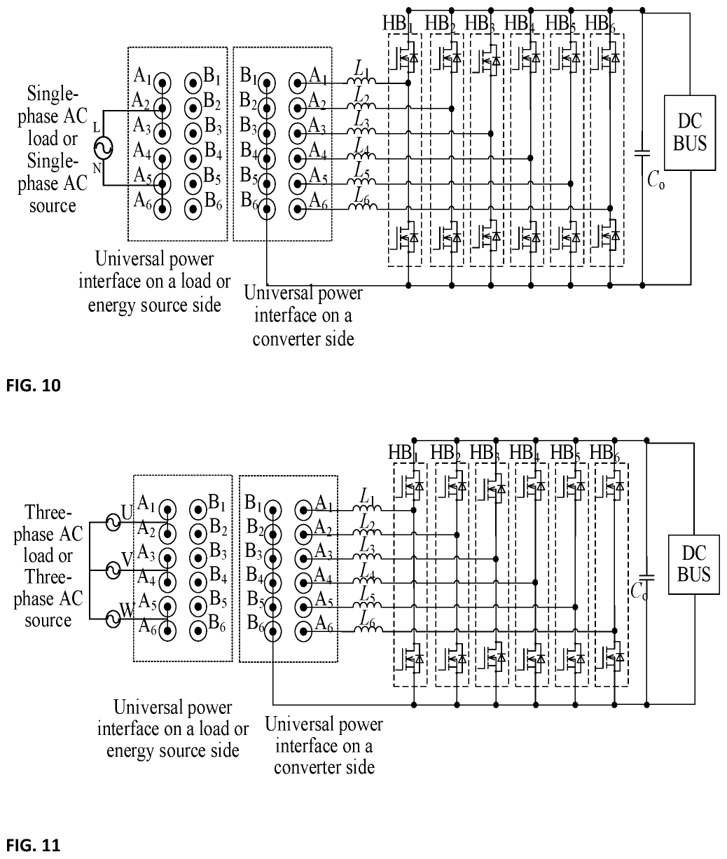

A single-phase rectification and inversion function is implemented based on the power converter and the universal power interface. As shown in FIG. 10, for a second power interface on a load or energy source side, A₁ to A₆ are connected to an L terminal of a single-phase load or a single-phase AC source, and A₄ to A₆ are connected to an N terminal of the single-phase load or the single-phase AC source; and for a first power interface on a power converter side, A₁ to A₆ are connected to the inductors of the basic units, and B₁ to B₆ are connected to the source terminals of the lower bridge arms of the half-bridges. In this case, the power converter can be used as three bridge rectification-inversion converters connected in parallel. Based on this converter, the non-isolated single-phase rectification and inversion function can be implemented.

### (4) Implementation of Non-Isolated Three-Phase Rectification and Inversion

A three-phase rectification and inversion function is implemented based on the power converter and the universal power interface. As shown in FIG. 11, for a second power interface on a load or energy source side, A₁ and A₂ are connected to a U phase of a three-phase load or a three-phase AC source, A₃ and A₄ are connected to a V phase of the three-phase load or the three-phase AC source, A₅ and A₆ are connected to a W phase of the three-phase load or the three-phase AC source, and B₁ to B₆ are floating; and for a first power interface on a power converter side, A₁ to A₆ are connected to the inductors of the basic units, and B₁ to B₆ are connected to the source terminals of the lower bridge arms of the half-bridges. In this case, the power converter can be used as two three-phase bridge rectification-inversion converters connected in parallel. Based on this converter, the non-isolated three-phase rectification and inversion function can be implemented.

### (5) Construction of an AC/DC Hybrid Microgrid System

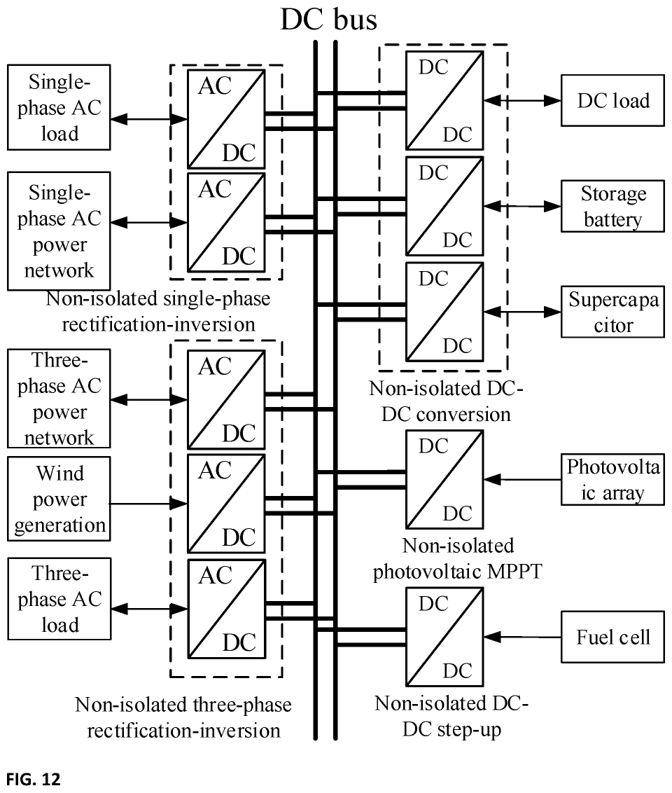

The AC/DC hybrid microgrid system is constructed based on the power converter and the universal power interface. As shown in FIG. 12, the power converter is used in all of non-isolated power conversions in the figure, and the converter is connected to each load or energy source through the universal power interface. All DC outputs of the power converter in the hybrid microgrid are connected to each other to fount a common-bus structure, so as to implement energy interconnection and power support.

Based on the foregoing solution, the power converter is adopted in the present disclosure for implementing all non-isolated power conversions required by an AC/DC hybrid microgrid, thereby simplifying the system design, and reducing the manufacturing costs. The universal power interface is adopted, so that connection modes between the power converter and various types of loads and energy sources in the microgrid become uniform. This implements mutual substitution of different functional converters in the hybrid microgrid, and reduces the system complexity and the later maintenance difficulty of the hybrid microgrid. Moreover, because the hybrid microgrid system constructed based on the power converter and the universal power interface has good modularization characteristics, the system layout and heat dissipation design of the hybrid microgrid system is simplified, and thus is beneficial to increase the power density of the system.

Each embodiment of this specification is described in a progressive manner, each embodiment focuses on the difference from other embodiments, and the same and similar parts between the examples may refer to each other.

In this specification, several examples are used for illustration of the principles and implementations of the present disclosure. The description of the foregoing embodiments is merely used to facilitate understanding of the method of the present disclosure and the core principles thereof In addition, persons of ordinary skill in the art can make various modifications in terms of specific implementations and scope of application in accordance with the teachings of the present disclosure. In conclusion, the content of this specification should not be construed as a limitation to the present disclosure.

1. A basic unit for a power converter, comprising an inductor, a power half-bridge, a first terminal, a second terminal, a third terminal, and a fourth terminal, wherein an end of the inductor is connected to a midpoint of the power half-bridge, and another end of the inductor is connected to the first terminal; a source terminal of a lower bridge arm of the power half-bridge is connected to the second terminal and the fourth terminal, and a drain terminal of an upper bridge arm of the power half-bridge is connected to the third terminal.

2. A power converter, wherein the power converter comprises a basic unit, the basic unit comprising: an inductor, a power half-bridge, a first terminal, a second terminal, a third terminal, and a fourth terminal, wherein an end of the inductor is connected to a midpoint of the power half-bridge, and another end of the inductor is connected to the first terminal; a source terminal of a lower bridge arm of the power half-bridge is connected to the second terminal and the fourth terminal, and a drain terminal of an upper bridge arm of the power half-bridge is connected to the third terminal, wherein there are 3 to 6N basic units in the power converter, wherein N is an integer greater than 1; the third terminals of all the basic units in the power converter are connected to a first terminal of an output capacitor and a positive terminal of a direct current (DC) bus, and the fourth terminals of all the basic units in the power converter are connected to a second terminal of the output capacitor and a negative terminal of the DC bus.

3. The power converter according to claim 2, wherein when the power converter is used for DC step-up or DC step-down, a first terminal of each basic unit in the power converter is connected to a positive terminal of a DC source, and a second terminal of each basic unit in the power converter is connected to a negative terminal of the DC source; or a first terminal of each basic unit in the power converter is connected to a positive terminal of a DC load, and a second terminal of each basic unit in the power converter is connected to a negative terminal of the DC load.

4. The power converter according to claim 2, wherein when the power converter is used for single-phase rectification and inversion, all the basic units in the power converter are divided into a plurality of groups of basic units, and each group of basic units comprises two basic units: a first basic unit and a second basic unit; in a same group of basic units, a first terminal of the first basic unit is connected to an L terminal of a single-phase alternating current (AC) source, a first terminal of the second basic unit is connected to an N terminal of the single-phase AC source, and a second terminal of the first basic unit and a second terminal of the second basic unit are floating; or in a same group of basic units, a first terminal of the first basic unit is connected to an L terminal of a single-phase AC load, a first terminal of the second basic unit is connected to an N terminal of the single-phase AC load, and a second terminal of the first basic unit and a second terminal of the second basic unit are floating.

5. The power converter according to claim 2, wherein when the power converter is used for three-phase rectification and inversion, all the basic units in the power converter are divided into a plurality of groups of basic units, each group of basic units comprises three basic units; first terminals of three basic units in a same group of basic units are respectively connected to a U phase, a V phase, and a W phase of a three-phase AC source, and second terminals of the three basic units are all floating; or first terminals of three basic units in a same group of basic units are respectively connected to a U phase, a V phase, and a W phase of a three-phase AC load, and second terminals of the three basic units are all floating.

6. A universal power interface, wherein the universal power interface is used for the power converter according to claim 2, and the power converter is connected to a load or an energy source in a microgrid through the universal power interface, wherein
the universal power interface comprises a first power interface and a second power interface, the first power interface comprises 6N first terminals and 6N second terminals, the second power interface comprises 6N third terminals and 6N fourth terminals, the 6N first terminals of the first power interface are connected to the 6N third terminals of the second power interface in a one-to-one correspondence, and the 6N second terminals of the first power interface are connected to the 6N fourth terminals of the second power interface in a one-to-one correspondence, wherein N is an integer greater than 0;
first terminals of all basic units in the power converter are connected to a plurality of first terminals of the first power interface in a one-to-one correspondence, and second terminals of all the basic units in the power converter are connected to a plurality of second terminals of the first power interface in a one-to-one correspondence; and
the load or the energy source in the microgrid is connected to the second power interface.

7. The universal power interface according to claim 6, wherein when the power converter is used for direct current (DC) step-up or DC step-down, m third terminals of the second power interface are connected to a positive terminal of a DC load after being connected in series, and m fourth terminals of the second power interface are connected to a negative terminal of the DC load after being connected in series; or m third terminals of the second power interface are connected to a positive terminal of a DC source after being connected in series, and m fourth terminals of the second power interface are connected to a negative terminal of the DC source after being connected in series,
wherein m is the number of the basic units in the power converter, the m third terminals of the second power interface are third terminals corresponding to m first terminals of the first power interface, and the m fourth terminals of the second power interface are fourth terminals corresponding to m second terminals of the first power interface.

8. The universal power interface according to claim 6, wherein when the power converter is used for single-phase rectification and inversion, n third terminals of the second power interface that are corresponding to a first group of first terminals of the first power interface are connected to an L terminal of a single-phase alternating current (AC) load after being connected in series, and n third terminals of the second power interface that are corresponding to a second group of first terminals of the first power interface are connected to an M terminal of the single-phase AC load after being connected in series; or n third terminals of the second power interface that are corresponding to a first group of first terminals of the first power interface are connected to an L terminal of a single-phase AC source after being connected in series, and n third terminals of the second power interface that are corresponding to a second group of first terminals of the first power interface are connected to an M terminal of the single-phase AC source after being connected in series, wherein n is the number of groups of basic units obtained by dividing all the basic units in the power converter; both the first group of first terminals and the second group of first terminals comprise n terminals, the first group of first terminals is connected to first terminals of n basic units in the power converter, the second group of first terminals is connected to first terminals of n basic units in the power converter, and the first group of first terminals and the second group of first terminals are corresponding to different basic units in the power converter.

9. The universal power interface according to claim 6, wherein when the power converter is used for three-phase rectification and inversion, h third terminals of the second power interface that are corresponding to a first group of first terminals of the first power interface are connected to a U phase of a three-phase AC source after being connected in series, h third terminals of the second power interface that are corresponding to a second group of first terminals of the first power interface are connected to a V phase of the three-phase AC source after being connected in series, and h third terminals of the second power interface that are corresponding to a third group of first terminals of the first power interface are connected to a W phase of the three-phase AC source after being connected in series; or h third terminals of the second power interface that are corresponding to a first group of first terminals of the first power interface are connected to a U phase of a three-phase AC load after being connected in series, h third terminals of the second power interface that are corresponding to a second group of first terminals of the first power interface are connected to a V phase of the three-phase AC load after being connected in series, and h first terminals of the second power interface that are corresponding to a third group of first terminals of the first power interface are connected to a W phase of the three-phase AC load after being connected in series,
wherein h is the number of groups of basic units obtained by dividing all the basic units in the power converter; all of the first group of first terminals, the second group of first terminals, and the second group of third terminals comprise h terminals; the first group of first terminals, the second group of first terminals, and the second group of third terminals are respectively connected to first terminals of 3h basic units in the power converter; and the first group of first terminals, the second group of first terminals, and the second group of third terminals are corresponding to different basic units in the power converter.

10. A universal power interface, wherein the universal power interface is used for a power converter, wherein the power converter comprises a basic unit, the basic unit comprising: an inductor, a power half-bridge, a first terminal, a second terminal, a third terminal, and a fourth terminal, wherein an end of the inductor is connected to a midpoint of the power half-bridge, and another end of the inductor is connected to the first terminal; a source terminal of a lower bridge arm of the power half-bridge is connected to the second terminal and the fourth terminal, and a drain terminal of an upper bridge arm of the power half-bridge is connected to the third terminal, wherein there are 3 to 6N basic units in the power converter, wherein N is an integer greater than 1; the third terminals of all the basic units in the power converter are connected to a first terminal of an output capacitor and a positive terminal of a direct current (DC) bus, and the fourth terminals of all the basic units in the power converter are connected to a second terminal of the output capacitor and a negative terminal of the DC bus, the power converter is used for DC step-up or DC step-down, a first terminal of each basic unit in the power converter is connected to a positive terminal of a DC source, and a second terminal of each basic unit in the power converter is connected to a negative terminal of the DC source; or a first terminal of each basic unit in the power converter is connected to a positive terminal of a DC load, and a second terminal of each basic unit in the power converter is connected to a negative terminal of the DC load,
wherein the power converter is connected to a load or an energy source in a microgrid through the universal power interface, wherein
the universal power interface comprises a first power interface and a second power interface, the first power interface comprises 6N first terminals and 6N second terminals, the second power interface comprises 6N third terminals and 6N fourth terminals, the 6N first terminals of the first power interface are connected to the 6N third terminals of the second power interface in a one-to-one correspondence, and the 6N second terminals of the first power interface are connected to the 6N fourth terminals of the second power interface in a one-to-one correspondence, wherein N is an integer greater than 0;
first terminals of all basic units in the power converter are connected to a plurality of first terminals of the first power interface in a one-to-one correspondence, and second terminals of all the basic units in the power converter are connected to a plurality of second terminals of the first power interface in a one-to-one correspondence; and
the load or the energy source in the microgrid is connected to the second power interface.

11. The universal power interface according to claim 10, wherein when the power converter is used for direct current (DC) step-up or DC step-down, m third terminals of the second power interface are connected to a positive terminal of a DC load after being connected in series, and m fourth terminals of the second power interface are connected to a negative terminal of the DC load after being connected in series; or m third terminals of the second power interface are connected to a positive terminal of a DC source after being connected in series, and m fourth terminals of the second power interface are connected to a negative terminal of the DC source after being connected in series,
wherein m is the number of the basic units in the power converter, the m third terminals of the second power interface are third terminals corresponding to m first terminals of the first power interface, and the m fourth terminals of the second power interface are fourth terminals corresponding to m second terminals of the first power interface.

12. The universal power interface according to claim 10, wherein when the power converter is used for single-phase rectification and inversion, n third terminals of the second power interface that are corresponding to a first group of first terminals of the first power interface are connected to an L terminal of a single-phase alternating current (AC) load after being connected in series, and n third terminals of the second power interface that are corresponding to a second group of first terminals of the first power interface are connected to an M terminal of the single-phase AC load after being connected in series; or n third terminals of the second power interface that are corresponding to a first group of first terminals of the first power interface are connected to an L terminal of a single-phase AC source after being connected in series, and n third terminals of the second power interface that are corresponding to a second group of first terminals of the first power interface are connected to an M terminal of the single-phase AC source after being connected in series,
wherein n is the number of groups of basic units obtained by dividing all the basic units in the power converter; both the first group of first terminals and the second group of first terminals comprise n terminals, the first group of first terminals is connected to first terminals of n basic units in the power converter, the second group of first terminals is connected to first terminals of n basic units in the power converter, and the first group of first terminals and the second group of first terminals are corresponding to different basic units in the power converter.

13. The universal power interface according to claim 10, wherein when the power converter is used for three-phase rectification and inversion, h third terminals of the second power interface that are corresponding to a first group of first terminals of the first power interface are connected to a U phase of a three-phase AC source after being connected in series, h third terminals of the second power interface that are corresponding to a second group of first terminals of the first power interface are connected to a V phase of the three-phase AC source after being connected in series, and h third terminals of the second power interface that are corresponding to a third group of first terminals of the first power interface are connected to a W phase of the three-phase AC source after being connected in series; or h third terminals of the second power interface that are corresponding to a first group of first terminals of the first power interface are connected to a U phase of a three-phase AC load after being connected in series, h third terminals of the second power interface that are corresponding to a second group of first terminals of the first power interface are connected to a V phase of the three-phase AC load after being connected in series, and h first terminals of the second power interface that are corresponding to a third group of first terminals of the first power interface are connected to a W phase of the three-phase AC load after being connected in series,
wherein h is the number of groups of basic units obtained by dividing all the basic units in the power converter; all of the first group of first terminals, the second group of first terminals, and the second group of third terminals comprise h terminals; the first group of first terminals, the second group of first terminals, and the second group of third terminals are respectively connected to first terminals of 3h basic units in the power converter; and the first group of first terminals, the second group of first terminals, and the second group of third terminals are corresponding to different basic units in the power converter.

14. A universal power interface, wherein the universal power interface is used for the power converter according to claim 10, and the power converter is connected to a load or an energy source in a microgrid through the universal power interface,
wherein when the power converter is used for single-phase rectification and inversion, all the basic units in the power converter are divided into a plurality of groups of basic units, and each group of basic units comprises two basic units: a first basic unit and a second basic unit; in a same group of basic units, a first terminal of the first basic unit is connected to an L terminal of a single-phase alternating current (AC) source, a first terminal of the second basic unit is connected to an N terminal of the single-phase AC source, and a second terminal of the first basic unit and a second terminal of the second basic unit are floating; or in a same group of basic units, a first terminal of the first basic unit is connected to an L terminal of a single-phase AC load, a first terminal of the second basic unit is connected to an N terminal of the single-phase AC load, and a second terminal of the first basic unit and a second terminal of the second basic unit are floating.

15. The universal power interface according to claim 14, wherein when the power converter is used for direct current (DC) step-up or DC step-down, m third terminals of the second power interface are connected to a positive terminal of a DC load after being connected in series, and m fourth terminals of the second power interface are connected to a negative terminal of the DC load after being connected in series; or m third terminals of the second power interface are connected to a positive terminal of a DC source after being connected in series, and m fourth terminals of the second power interface are connected to a negative terminal of the DC source after being connected in series,
wherein m is the number of the basic units in the power converter, the m third terminals of the second power interface are third terminals corresponding to m first terminals of the first power interface, and the m fourth terminals of the second power interface are fourth terminals corresponding to m second terminals of the first power interface.

16. The universal power interface according to claim 14, wherein when the power converter is used for single-phase rectification and inversion, n third terminals of the second power interface that are corresponding to a first group of first terminals of the first power interface are connected to an L terminal of a single-phase alternating current (AC) load after being connected in series, and n third terminals of the second power interface that are corresponding to a second group of first terminals of the first power interface are connected to an M terminal of the single-phase AC load after being connected in series; or n third terminals of the second power interface that are corresponding to a first group of first terminals of the first power interface are connected to an L terminal of a single-phase AC source after being connected in series, and n third terminals of the second power interface that are corresponding to a second group of first terminals of the first power interface are connected to an M terminal of the single-phase AC source after being connected in series,
wherein n is the number of groups of basic units obtained by dividing all the basic units in the power converter; both the first group of first terminals and the second group of first terminals comprise n terminals, the first group of first terminals is connected to first terminals of n basic units in the power converter, the second group of first terminals is connected to first terminals of n basic units in the power converter, and the first group of first terminals and the second group of first terminals are corresponding to different basic units in the power converter.

17. The universal power interface according to claim 14, wherein when the power converter is used for three-phase rectification and inversion, h third terminals of the second power interface that are corresponding to a first group of first terminals of the first power interface are connected to a U phase of a three-phase AC source after being connected in series, h third terminals of the second power interface that are corresponding to a second group of first terminals of the first power interface are connected to a V phase of the three-phase AC source after being connected in series, and h third terminals of the second power interface that are corresponding to a third group of first terminals of the first power interface are connected to a W phase of the three-phase AC source after being connected in series; or h third terminals of the second power interface that are corresponding to a first group of first terminals of the first power interface are connected to a U phase of a three-phase AC load after being connected in series, h third terminals of the second power interface that are corresponding to a second group of first terminals of the first power interface are connected to a V phase of the three-phase AC load after being connected in series, and h first terminals of the second power interface that are corresponding to a third group of first terminals of the first power interface are connected to a W phase of the three-phase AC load after being connected in series,
wherein h is the number of groups of basic units obtained by dividing all the basic units in the power converter; all of the first group of first terminals, the second group of first terminals, and the second group of third terminals comprise h terminals; the first group of first terminals, the second group of first terminals, and the second group of third terminals are respectively connected to first terminals of 3h basic units in the power converter; and the first group of first terminals, the second group of first terminals, and the second group of third terminals are corresponding to different basic units in the power converter.

18. A universal power interface, wherein the universal power interface is used for the power converter according to claim 10, and the power converter is connected to a load or an energy source in a microgrid through the universal power interface,
wherein when the power converter is used for three-phase rectification and inversion, all the basic units in the power converter are divided into a plurality of groups of basic units, each group of basic units comprises three basic units; first terminals of three basic units in a same group of basic units are respectively connected to a U phase, a V phase, and a W phase of a three-phase AC source, and second terminals of the three basic units are all floating; or first terminals of three basic units in a same group of basic units are respectively connected to a U phase, a V phase, and a W phase of a three-phase AC load, and second terminals of the three basic units are all floating.

19. The universal power interface according to claim 18, wherein when the power converter is used for direct current (DC) step-up or DC step-down, m third terminals of the second power interface are connected to a positive terminal of a DC load after being connected in series, and m fourth terminals of the second power interface are connected to a negative terminal of the DC load after being connected in series; or m third terminals of the second power interface are connected to a positive terminal of a DC source after being connected in series, and m fourth terminals of the second power interface are connected to a negative terminal of the DC source after being connected in series,
wherein m is the number of the basic units in the power converter, the m third terminals of the second power interface are third terminals corresponding to m first terminals of the first power interface, and the m fourth terminals of the second power interface are fourth terminals corresponding to m second terminals of the first power interface.

20. The universal power interface according to claim 18, wherein when the power converter is used for single-phase rectification and inversion, n third terminals of the second power interface that are corresponding to a first group of first terminals of the first power interface are connected to an L terminal of a single-phase alternating current (AC) load after being connected in series, and n third terminals of the second power interface that are corresponding to a second group of first terminals of the first power interface are connected to an M terminal of the single-phase AC load after being connected in series; or n third terminals of the second power interface that are corresponding to a first group of first terminals of the first power interface are connected to an L terminal of a single-phase AC source after being connected in series, and n third terminals of the second power interface that are corresponding to a second group of first terminals of the first power interface are connected to an M terminal of the single-phase AC source after being connected in series,
wherein n is the number of groups of basic units obtained by dividing all the basic units in the power converter; both the first group of first terminals and the second group of first terminals comprise n terminals, the first group of first terminals is connected to first terminals of n basic units in the power converter, the second group of first terminals is connected to first terminals of n basic units in the power converter, and the first group of first terminals and the second group of first terminals are corresponding to different basic units in the power converter.
